(19) United States
(12) Patent Application Publication
(10) Pub. No.: US 2011/0234905 A1
(43) Pub. Date: Sep. 29, 2011

(54) Music amplifier/ mixer

(76) Inventor: David Su, City of Industry, CA (US)

(21) Appl. No.: 12/798,100

(22) Filed: Mar. 29, 2010

(51) Int. Cl. H04N 3/27; H04B 1/00

(52) U.S. Cl. 348/554; 381/119; 348/E03.049

(57) ABSTRACT

A music mixer has an input component comprising a plurality of input sources to provide audio/video input signals; an audio/video processing component selectively receiving the input signals from the input component, processing and mixing the audio/video input signals to generate audio/video output signals and control information; and an output component outputting the audio/video output, wherein the output component further provides visual image of the video output signals and the control information.

### BACKGROUND OF THE PRESENT INVENTION

1. Field of Invention

The present invention relates to a audio mixer, and more particularly to a music mixer with amplifier and output monitor.

2. Description of Related Arts

A music mixer is also called audio mixer which is an electrical device to process and combine multiple audio inputs together to form an output audio signal. This signal will be transferred to output devices such as loud speakers for producing audible sound. The output signal includes analog signal and digital signal. Often time, the voltage level of the output signal is low and needs an amplifier to increase the signal power to drive the output devices.

Most music mixers have multiple audio input channels and many functions to process the audio inputs. For example, the user needs to select different input channels, adjust timbre, routing, and level of the input, and sometimes needs to monitor the video output of sources such as DVD. To handle all these channels and functions to form the request sound effects, an operator or a DJ must be very experienced because most of these inputs are monitored by the operator's audition. For people without enough training, it is very difficult for them to evaluate the quality of the sound, and to make suitable adjustment of the mixer to improve the sound effects. In addition, when the output of a mixer is occupied by one input source, operator cannot monitor other input source at the same time. Some input sources are combined with video signals such as DVD, so extra video devices are require for monitoring. Although some mixer use LED to indicate the volume of the output signal at different frequencies, there is not accurate and reliable way for the operator to monitor the input and output of the mixer.

Also, the output signal of current using music mixers can only be monitored lively which means there is no playback function. If the user want to listen to the played music, an external recording equipment must be used, and an output channel will be occupied. In addition, the output signals which are recorded by the external equipments are analog signals which is inconvenient to store and process.

Therefore, a music mixer with visible monitor and recording capability is needed.

### SUMMARY OF THE PRESENT INVENTION

With the development of analog and digital signal processing technique, audio and video signals are able to be indicated and processed in many manners. This provides a lot of capability to monitor and process the signals. In the present invention, besides listen to the sound, the mixer enable the operator to “see” the sound. The audio signals are described graphically and numerically therefore the operator is able to monitor the property of the signals which is much more accurate and reliable. The output of the mixer of the present invention is also able to be recorded in different formats to provide a lot of convenience and flexibility to the operator.

An object of the present invention is to provide a music mixer which input and output can be monitored visually.

Another object of the present invention is to provide a music mixer which provides graphic information to indicate the audio signals.

Another object of the present invention is to provide a music mixer which provides numeric information to indicate the audio signals.

Another object of the present invention is to provide a music mixer which displays video signals.

Another object of the present invention is to provide a music mixer which output is able to be recorded.

Another object of the present invention is to provide a music mixer which output is able to be recorded in different formats.

Another object of the present invention is to provide a music mixer which output is converted to digital signal for further processing.

Another object of the present invention is to provide a music mixer having an internal amplifier.

In order to accomplish the above objects, the present invention provides a music mixer, comprising:

an input component comprising a plurality of individual input terminals for communicatively linking with a plurality of audio/video sources respectively to receive audio/video input signals therefrom;

an audio/video processing component operatively linking to the input component for enhancing and modifying the audio/video input signals therefrom so as to generate audio/video output signals and corresponding control information;

an output component outputting the audio/video output signals; and

a monitoring device operatively linking to the input component for monitoring the audio/video sources in a previewing manner, wherein the input component is supervised by the monitoring device for individually selecting the audio/video input signals from the audio/video sources to be input to the audio/video processing component in such a manner that the audio/video input signals are adapted to be selectively adjusted in responsive to the control information before the audio/video output signals are generated.

In addition, the present invention provides a music mixer, comprising:

an input component comprising a plurality of input sources to provide audio input signals;

an audio processing component selectively receiving the input signals from the input component, processing the audio input signals and mixing the processed signals to form an audio output signal; and

an output component outputting the processed output signal wherein further comprises a recording device recording the output signals in predetermined format.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an embodiment of the present invention.

FIG. 2 is a front view of an embodiment of the present invention.

FIG. 3 is a block diagram of an embodiment of the present invention.

FIG. 4 is a flow chart of the method of processing audio/video signal by a music mixer.

### DETAILED DESCRIPTION OF THE PREFERRED EMBODIMENT

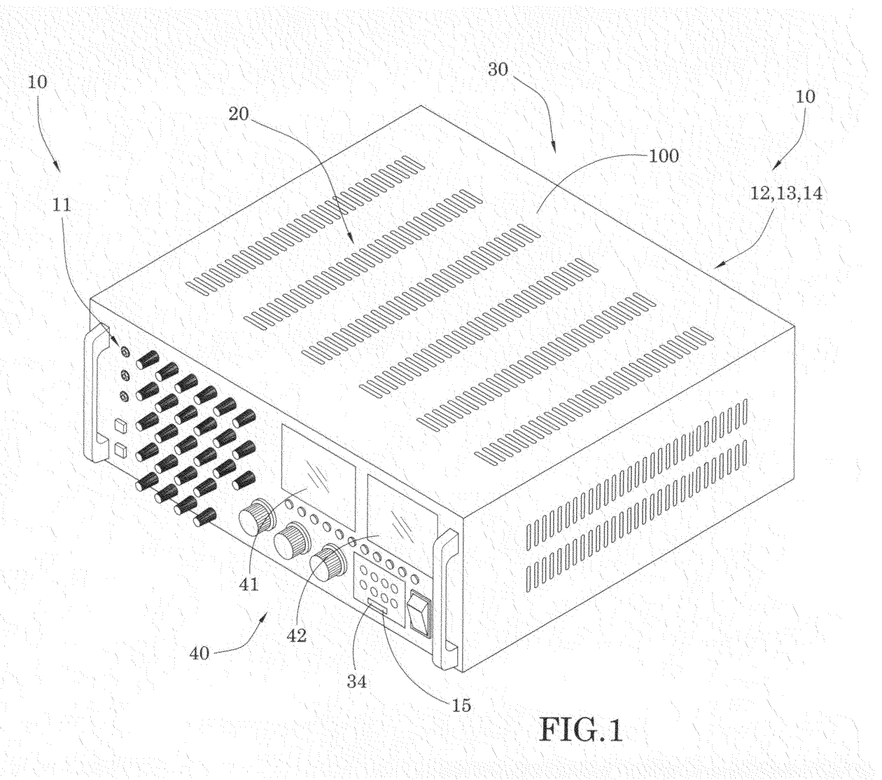

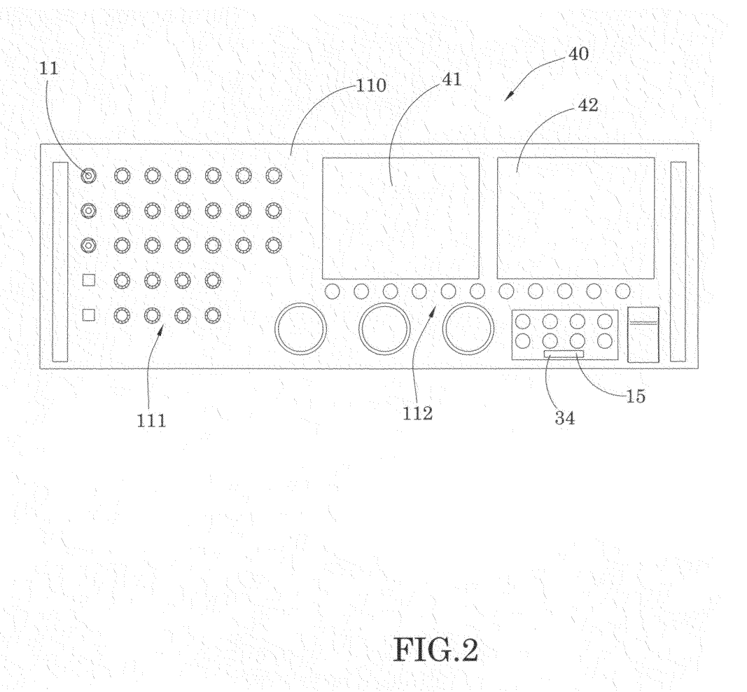

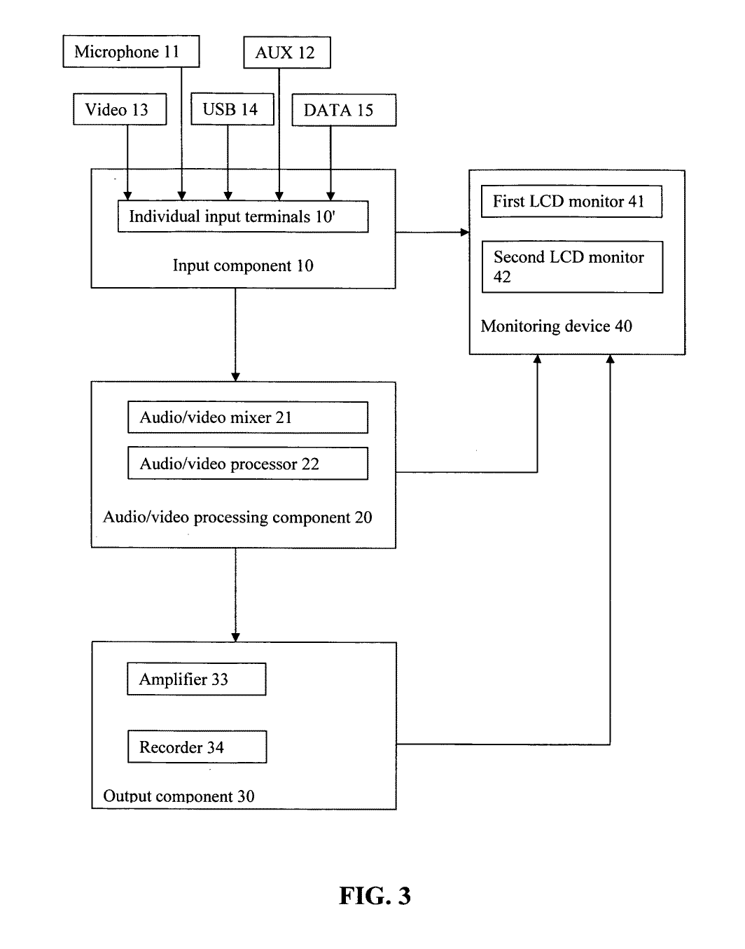

Referring to FIGS. 1 to 3 of the drawings, in a preferred embodiment of the present invention, a music mixer comprises an input component 10 having a plurality of individual input terminals 10′, an audio/video processing component 20, and an output component 30.

The individual input terminals 10′ further comprises one or more microphone input channels 11 for collecting vocal signals, one or more auxiliary (AUX) input channel 12 for receiving external audio sources, one or more video input channels 13 for inputting video signals which are communicatively connected with a plurality of audio/video input signals including.

In a preferred embodiment of the present invention, the individual input terminals 10′ also comprise digital signal input sources which include a USB port 14 to receive data from external electronic devices such as PC, and a data storage reader 15 to read data from a data storage. Preferably, the storage reader is a SD card reader, and the data storage is a SD card. Alternatively, other types of data storage such as Hard Drive, Memory Stick, etc. are also available. The digital signals have different types or formats to carry the audio, graphic, and/or video information. The audio formats include MP3, WAV, WMA, MPEG4, etc. In a preferred embodiment, the digital signals include MP3+G which carries both MP3 data and graphic data such as lyric of the song, screen background, logos and symbols.

The input component 10 are electrically connected with the audio/video processing component 20 to transfer the audio and video signals. The audio processing comprises an audio/video mixer 21 to mix the vocal signals collected from the microphone input channels 11 and sound signals collected from the audio/video input sources to form mixed signals, and an audio/video processor 22 to process the mixed signals to generate output signals. The audio/video processor 22 provides a plurality of functions for processing the audio and video signals such as mixing, volume control, equalization, gain control, etc. These functions enable the user of the mixer to form required audio and video output signals, and adjust the effect of the audio and video output signals.

By processing the input signals, the audio/video processor 22 also generates relative control information. The control information comprises the status of the input source such as which input sources are available and which are selected to be processed, the control parameters such as the gain level, volume, balance, parameters of equalization, etc.

The audio/video processor 22 also decoding the input digital data to generate audio and video signals for output. In the preferred embodiment of the present invention, the audio/video processor 22 selects input from the USB or from the SD card, and decodes the data to generate audio signals for further process such as mixing and adjusting. If the data also includes graphic information, for example MP3+G, the audio/video processor 22 also decode the graphic signal and generates the graphic signals.

The audio/video processor 22 is electrically connected with the output component 30 to transfer the processed audio and video signals, control information and graphic signals for output. In a preferred embodiment, the output component 30 also comprises a first audio/video selector 31, a second audio/video selector 32, and an amplifier 33. The first audio/video selector is electrically connected with the amplifier and is adapted to transfer the output of the mixer to the external output device such as loud speakers. In the preferred embodiment, the output component 30 also comprises a recorder 34. The recorder is electrically connected with the audio/video selector to receive the output signal of the mixer and record the output signals. In a preferred embodiment, the audio signal of the output signals is selected and recorded in MP3 format. And the recorder is a SD card writer. The output audio signal is converted into MP3 format and is recorded in a SD card by the SD card writer to realize recording. In alternative embodiments, other formats are also available. As well, other types of recording devices and media are also utilized for recording. The audio formats include MP3, WAV, WMA, MPEG4, etc. The recording media include Hard Drive, Memory Stick, CD, DVD, etc.

It is worth mentioning, in the preferred embodiment, the recorder is integrated within the mixer. Alternatively, the recorder is an external device and is communicatively connected with the mixer trough wire or wireless connection.

In the preferred embodiment, the SD card reader and writer are combined together and share a same card slot. Therefore, the mixer of the present invention can record the output in a SD card can play back what is recorded immediately. This provides a lot of convenience for the user.

The music mixer of the present invention further comprises a monitoring device 40 which is electrically connected with the input component 10 for monitoring the audio/video sources in a previewing manner. The monitoring device 40 enable the operator to monitor the selection of individual input terminals, the adjusting of the input signals. The monitoring device 40 is also electrically connected with the audio/video processing component to receive the control information to display the processing status. The monitoring device 40 is further connected with the output component 30 therefore to display the output signals. In a preferred embodiment of the present invention, the monitoring device 40 comprises one or more LCD monitors to display the video signals received from the input terminals, control information received from the of the audio/video processor 22 to the monitoring device 40. The output signals comprise video signals, graphic signals, and control information. The monitoring device 40 then display the video, graph, and control information as selected by the user.

The monitoring device 40 enables the operator to supervise the performance of the input component 10 in a preview manner. When the music mixer of the present invention is outputting one source of signal, the operator can listen to the output directly. But as the same time the operator is able to monitor another input source and adjust the input source by visual signals through the monitoring device 40.

In the preferred embodiment of the present invention, the output component 30 of the mixer comprises a first LCD monitor 41 and a second LCD monitor 42. The first LCD monitor 41 displays the video and graph. For example, when the DVD video is selected, the first LCD monitor 41 will display the DVD video; when the MP3+G is selected, the first LCD monitor 41 will display the graphic information carried by the MP3+G file such as background, lyric of the song, symbol or logo, etc. In this way, the operator can monitor lively what is outputted as video signals.

The second LCD monitor 42 displays the control information. The control information comprises the parameters of the audio signals such as balance, volume, tune, equalization, etc. This information is displayed in various manner for the operator's convenience to monitor. In the preferred embodiment, the information is displayed as number and graph to provide the operator a visual indication.

In the preferred embodiment of the present invention, the music mixer also comprises a casing body 100 which receives all the components of the music mixer. The casing body 100 also comprises a front panel 110 which has a plurality of control knobs 111 and control buttons 112 located thereon for the operator to adjust the setting of the mixer. The first and second LCD monitors 41, 42 are also installed on the front panel for the operator to observe.

In an alternative embodiment, the monitoring device 40 is an external device which is communicatively connected with the second audio/video selector to receive the output signals. The external device is a TV set or a PC.

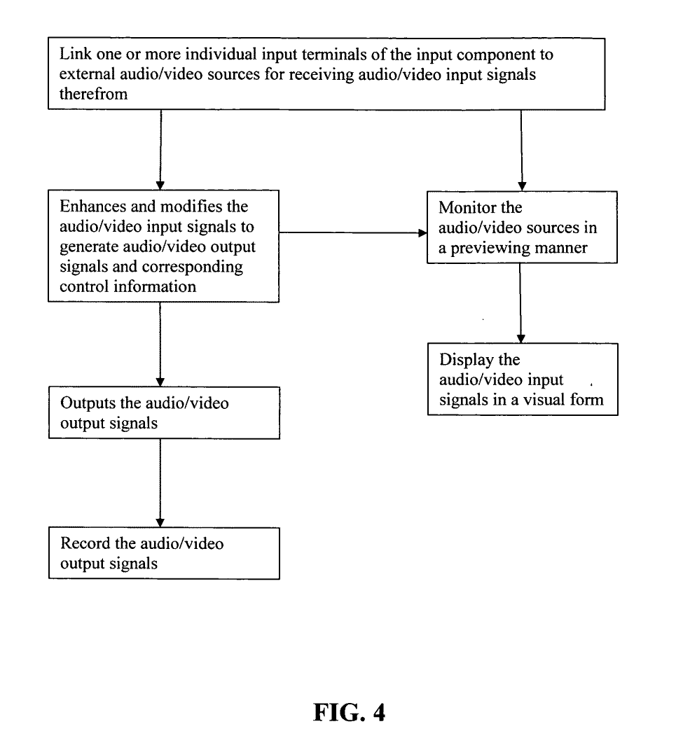

The present invention also provides a method of processing audio/video input signals from a plurality of audio/video sources using the music mixer mentioned above. Referring to FIG. 4 of the drawings, the music mixer first connects the one or more individual input terminals of the input component to external audio/video sources for receiving audio/video input signals therefrom; then the audio/video processing component enhances and modifies the audio/video input signals to generate audio/video output signals and corresponding control information; after the processing, the output component outputs the audio/video output signals; at the same time, the audio/video sources is monitored in a previewing manner, wherein the input component is supervised by the monitoring device for individually selecting the audio/video input signals from the audio/video sources to be input to the audio/video processing component in such a manner that the audio/video input signals are adapted to be selectively adjusted in responsive to the control information before the audio/video output signals are generated.

The monitoring device displays all the information in visible manner therefore the operator can see the information. In a preferred embodiment, the monitoring device displays the monitoring information in numerical form, graphical from, and video form through one or more LCD monitors. In addition, the monitoring device also display the video signals received from the input component. The video signals may or may not be processed. It may include DVD signal, or graphic signals such as MP3+G.

It is worth mentioning, the method also comprises all the regular steps for processing audio/video signals such as mixing and amplifying.

In summary, the mixer of the present invention provides output recording function and visual monitoring function. There two functions largely help the operator of the mixer to control and adjust the performance of the mixer. Besides hearing the audio output for speakers or ear phone, the operator can also monitoring the video output and all the control parameters. Also, the audio output is able to be recorded for later usage.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A music mixer, comprising:
an input component comprising a plurality of individual input terminals for communicatively linking with a plurality of audio/video sources respectively to receive audio/video input signals therefrom;
an audio/video processing component operatively linking to said input component for enhancing and modifying said audio/video input signals therefrom so as to generate audio/video output signals and corresponding control information;
an output component outputting said audio/video output signals; and
a monitoring device operatively linking to said input component for monitoring said audio/video sources in a previewing manner, wherein said input component is supervised by said monitoring device for individually selecting said audio/video input signals from said audio/video sources to be input to said audio/video processing component in such a manner that said audio/video input signals are adapted to be selectively adjusted in responsive to said control information before said audio/video output signals are generated.

2. The music mixer, as recited in claim 1, wherein said monitoring device comprises a monitoring display visually displaying said audio/video input signals to be monitored.

3. The music mixer, as recited in claim 2, wherein said monitoring device further comprises an output display visually displaying said audio/video output signals.

4. The music mixer, as recited in claim 3, wherein said audio/video input signals are displayed in a visual form selected from the group consisting of video form, numerical form, and graphical form.

5. The music mixer, as recited in claim 1, wherein said audio/video processing component comprises an audio/video mixer mixing a vocal signal with said audio/video input signals, an audio/video amplifier enhancing said audio/video output signals to be output, and a control interface selectively and adjustably controlling audio/video mixer and said audio/video amplifier for enhancing and modifying said audio/video input signals.

6. The music mixer, as recited in claim 4, wherein said audio/video processing component comprises an audio/video mixer mixing a vocal signal with said audio/video input signals, an audio/video amplifier enhancing said audio/video output signals to be output, and a control interface selectively and adjustably controlling audio/video mixer and said audio/video amplifier for enhancing and modifying said audio/video input signals.

7. The music mixer, as recited in claim 1, further comprising a recording device operatively linking to said output component for recording said audio/video output signals.

8. The music mixer, as recited in claim 6, further comprising a recording device operatively linking to said output component for recording said audio/video output signals.

9. The music mixer, as recited in claim 1, further comprising a casing body receiving said audio/video processing component therein and a front control panel at a front side of said casing body, wherein said monitoring device is provided at said front control panel to monitor said input component.

10. The music mixer, as recited in claim 8, further comprising a casing body receiving said audio/video processing component therein and a front control panel at a front side of said casing body, wherein said monitoring device is provided at said front control panel to monitor said input component.

11. The music mixer, as recited in claim 1, wherein said input terminals are selected from the group consisting of DVD input, microphone input, audio input, and “USB” input.

12. The music mixer, as recited in claim 10, wherein said input terminals are selected from the group consisting of DVD input, microphone input, audio input, and “USB” input.

13. A method of processing audio/video input signals from a plurality of audio/video sources by a music mixer which comprises input component, an audio/video processing component, an output component, and a monitoring device, wherein the method comprises the steps of:
(a) linking a plurality of individual input terminals of said input component to said audio/video sources for receiving said audio/video input signals therefrom;
(b) enhancing and modifying said audio/video input signals by said audio/video processing component to generate audio/video output signals and corresponding control information;
(c) outputting said audio/video output signals by said output component; and
(d) monitoring said audio/video sources in a previewing manner, wherein said input component is supervised by said monitoring device for individually selecting said audio/video input signals from said audio/video sources to be input to said audio/video processing component in such a manner that said audio/video input signals are adapted to be selectively adjusted in responsive to said control information before said audio/video output signals are generated.

14. The method, as recited in claim 13, wherein the step (d) further comprises a step (d.1) of visually displaying said audio/video input signals to be monitored on a monitoring display of said monitoring device.

15. The method, as recited in claim 14, wherein the step (d) further comprises a step (d.2) of visually displaying said audio/video output signals on an output display of said monitoring device.

16. The method, as recited in claim 15, wherein said audio/video input signals are displayed in a visual form selected from the group consisting of video form, numerical form, and graphical form.

17. The method, as recited in claim 16, wherein the step (b) comprises a step of mixing a vocal signal with said audio/video input signals and amplifying said audio/video output signals to be output.

18. The method, as recited in claim 13, further comprising a step of recording said audio/video output signals.

19. The method, as recited in claim 17, further comprising a step of recording said audio/video output signals.

20. The method, as recited in claim 19, wherein said input terminals are selected from the group consisting of DVD input, microphone input, audio input, and “USB” input.

21. A music mixer, comprising:
an input component comprising a plurality of individual input terminals for communicatively linking with a plurality of audio/video sources respectively to receive audio/video input signals therefrom;
an audio/video processing component operatively linking to said input component for enhancing and modifying said audio/video input signals therefrom so as to generate audio/video output signals and corresponding control information;
an output component outputting said audio/video output signals; and
a recording device operatively linking to said output component for recording said audio/video output signals.

22. The music mixer, as recited in claim 21, wherein said recording device comprises a signal converter converting said audio/video output signals into a predetermined digital readable format, and a digital reader outputting said audio/video output signals in digital readable format to an external digital storage so as to record said audio/video output signals on said external digital storage.

23. The music mixer, as recited in claim 22, further comprising a casing body receiving said audio/video processing component therein and a front control panel at a front side of said casing body, wherein said digital reader comprises a recorder terminal provided at said front control panel for operatively connecting to said external digital storage.

24. The music mixer, as recited in claim 21, wherein said audio/video processing component comprises an audio/video mixer mixing a vocal signal with said audio/video input signals, an audio/video amplifier enhancing said audio/video output signals to be output, and a control interface selectively and adjustably controlling audio/video mixer and said audio/video amplifier for enhancing and modifying said audio/video input signals.

25. The music mixer, as recited in claim 23, wherein said audio/video processing component comprises an audio/video mixer mixing a vocal signal with said audio/video input signals, an audio/video amplifier enhancing said audio/video output signals to be output, and a control interface selectively and adjustably controlling audio/video mixer and said audio/video amplifier for enhancing and modifying said audio/video input signals.
